(19) United States
(12) Patent Application Publication
(10) Pub. No.: US 2009/0083336 A1
(43) Pub. Date: Mar. 26, 2009

(54) SEARCH BASED DATA MANAGEMENT

(75) Inventor: Charumathy Srinivasan, hyderabad (IN)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/861,951

(22) Filed: Sep. 26, 2007

(51) Int. Cl. G06F 17/30

(52) U.S. Cl. 707/200; 707/E17.001

(57) ABSTRACT

The invention includes a system including a one or more storage devices including the data items a metadata tagging component for associating metadata to each data item, a policy component defining one or more data management polices as a function of the metadata, a search engine for generating a list of data items satisfying the data management policy, and a data management application for applying the data management policy to each data item in the list of data items generated by the search engine.

### BACKGROUND

Business and regulatory compliance are demanding online access to information. The amount of online backup data is growing significantly and this information is now being retained online for months-to-years. The problem is getting worse, as the size and complexity of computing environments increase, with large enterprises having many hundreds of thousands of computers. Data growth is the primary motivator for large scale storage deployments and the need to meaningfully manage this plethora of information becomes imperative. Often, data retention suffers from the problem of indiscriminate archiving. Allowing enterprises who have invested in data management products and storage infrastructures to separate the wheat from the chaff becomes critical.

Conventional data management products model the data management policy using static scope specifiers such as folders in file systems, databases in database management systems. In essence, the scope specifier is tied to a particular end point on a physical machine. While these techniques give a large degree of control to the data management administrator, they also significantly increase the onus on the end user to ensure that the piece of data that the policy applies to needs to be located within the confines of the physical end point. Both new data that needs to have the policy applied or existing data that no longer needs the policy applied result in either end user intervention or administrator intervention to ensure correctness.

Administrators sometimes manage the complexity of this problem by ensuring that end users follow specific processes such as always storing important data on specific shares on file servers to guarantee that the data on those file servers can be backed up. Often such processes are not sufficient to ensure that all data that needs the management policy applied correctly reflect the enterprise's intent. In many scenarios, the lack of such process results in huge legal penalties because the enterprise did not adhere to specified compliance requirements.

### SUMMARY

Embodiments of the invention include managing a plurality data items associated with a one or more servers of an enterprise. In an embodiment, the invention includes one or more storage devices including the data items a metadata tagging component for associating metadata to each data item, a policy component defining one or more data management polices as a function of the metadata, a search engine for generating a list of data items satisfying the data management policy, and a data management application for applying the data management policy to each data item in the list of data items generated by the search engine.

In another embodiment, the systems and methods include a secondary storage of the enterprise for storing data items of a second priority and the storage device includes data items of a first priority. The data management policy comprises an archival policy such data items satisfying said archival policy are to be moved from the storage devices to the secondary storage. The search engine generates a list of data items such that the metadata associated with each data item satisfies the archival policy and the data management application moves each data item in the list of data items from the storage device to secondary storage.

In yet another embodiment, the systems and methods defines a retention policy as a function of the metadata. Data items not satisfying are retention policy are to be deleted. The search engine executes the search including the retention search criteria to generate a list of data items such that the metadata associated with each data item does not satisfy the retention policy and the data management application is configured as a function of the generated list of data items such the data management application deletes each data item in the list of data items.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary flow chart illustrating an embodiment of a method for backing up a data item associated with a server of an enterprise.

FIG. 2 is an exemplary flow chart illustrating an embodiment of a method for achieving a data item associated with a server of an enterprise.

FIG. 3 is a block diagram illustrating one example of a suitable computing system environment in which the invention may be implemented.

Corresponding reference characters indicate corresponding parts throughout the drawings.

### DETAILED DESCRIPTION

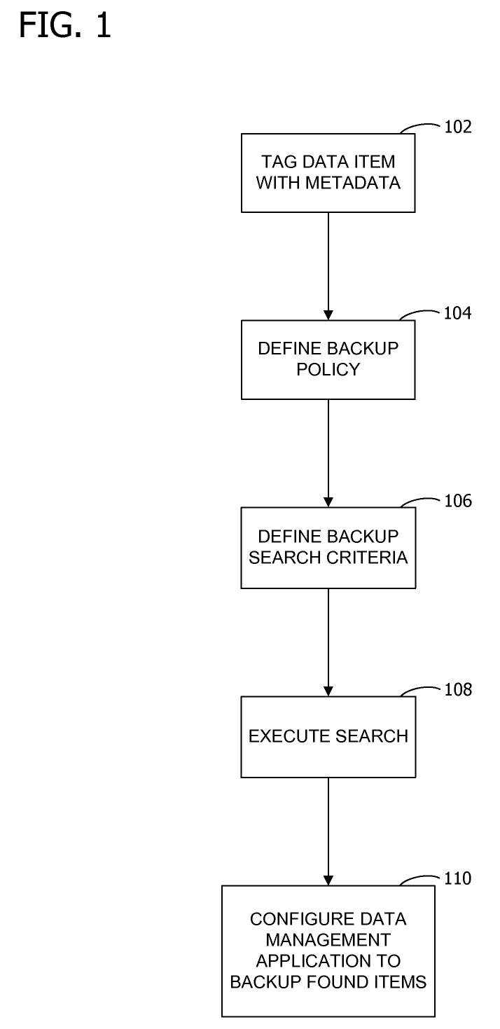

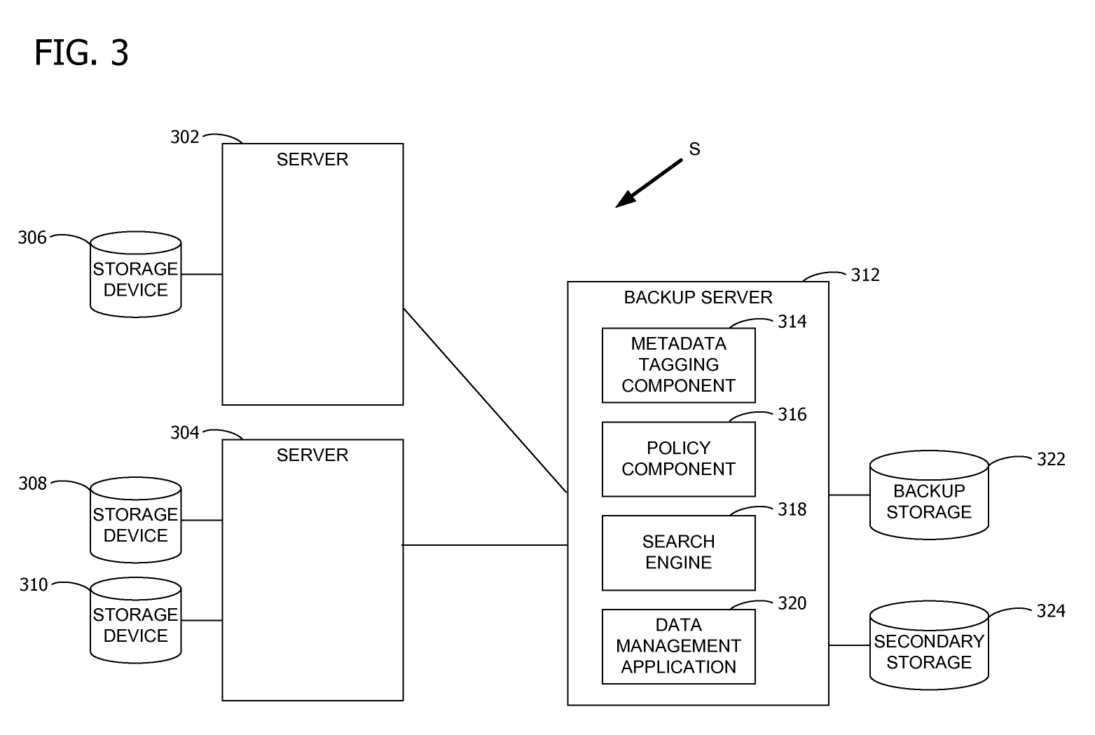

FIG. 1 is a flow diagram for an embodiment of a method for backing up a data item associated with a server (e.g., server 302, server 304; see FIG. 3) of an enterprise. At 102, a metadata tagging component 314 tagging the data item with metadata. The metadata describes one or more attributes of the data item. In an embodiment, the data item is tagged with metadata by one or more of the following: a database application, a storage management application, a directory server application, a storage file system, a mail server application, a user administration application and a collaboration server application. Alternatively, the data item is tagged with metadata by an owner of the data item. In an embodiment, the metadata indicates one or more of the following: a priority of the data item, a owner of the data item, a group of the data item, a last accessed time of the data item, a last modified time of the data item, a created time of the data item, an archival time of the data item, a logical location of the data item and a physical location of the data item.

At 104, the policy component 316 defines a backup policy as a function of the metadata. And, at 106, backup search criteria is defined as a function of the backup policy. At 108, the search engine 318 executes a search including the backup search criteria to generate a list of data items. The metadata associated with each data item satisfies the defined backup policy. At 110, a data management application 320 is configured as a function of the generated list of data items. The data management application 320 produces a backup of each data item in the generated list of data items.

For example, the backup search criteria may contain a single value such as a specific volume belonging to unique computer name to identify a specific endpoint on a machine such as “HRDepartmentAsset” to find all the machines that belong to the Human Resources department that might need a uniform application of the data management policy, or “mission-critical” to find all mission-critical systems. The backup search criteria may also be combined, such as “mission-critical HRDepartmentAsset,” such that all systems that match all or some criteria are found. Advantageously, as the data characteristics change or as new data gets created and tagged appropriately, the data management infrastructure in the enterprise can automatically apply policy to the data.

In an embodiment, at 104 the policy component 316 defines a retention policy as a function of the metadata. Data items not satisfying the retention policy are to be deleted. At 106, a retention search criteria is defined as a function of the retention policy. At 108, the search engine 318 executes the search including the retention search criteria to generate a list of data items such that the metadata associated with each data item does not satisfy the retention policy. At 110, the data management application 320 is configured as a function of the generated list of data items such the data management application deletes each data item in the list of data items.

In another embodiment, the primary storage (e.g. backup storage 322) is defined for the enterprise for storing data items of a first priority and secondary storage 324 is defined for storing data items of a second priority. In an embodiment, the primary storage (e.g. backup storage 322) includes online storage and the secondary storage 324 includes near online and offline storage. In another embodiment, the online storage comprises one or more storage devices that are activated and ready for operation. In this embodiment, the offline storage comprises one or more storage devices are not readily available to the server.

At 104, the policy component 316 defines an archival policy as a function of the metadata such that data items satisfying said archival policy are to be moved from the primary storage (e.g. backup storage 322) to the secondary storage 324. At 106, an archival search criteria is defined as a function of the archival policy. At 108, the search engine 318 executes the search including the archival search criteria to generate a list of data items such that the metadata associated with each data item satisfies the archival policy. And, at 110, the data management application 320 is configured as a function of the generated list of data items such that the data management application 320 moves each data item in the list of data items from primary storage (e.g. backup storage 322) to secondary storage 324.

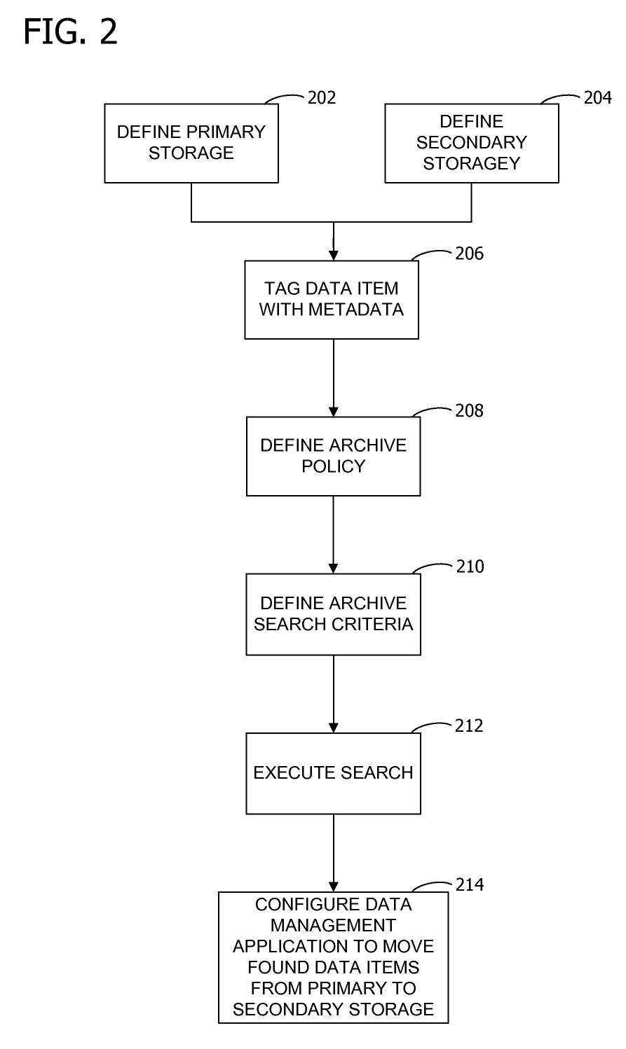

FIG. 2 is a flow diagram illustrating a method for archiving a data item associated with a server. At 202, primary storage (e.g. backup storage 322) of the server for storing data items of a first priority is defined and at 204 secondary storage 324 of the server for storing data items of a second priority is defined. In an embodiment, the primary storage (e.g. backup storage 322) includes online storage and the secondary storage 324 includes near online and offline storage. In another embodiment, the online storage comprises one or more storage devices that are activated and ready for operation and the offline storage comprises one or more storage devices that are not readily available to the server.

At 206, the metadata tagging component 314 tags the data item with metadata describing one or more attributes of the data item. In an embodiment, the metadata is associated with the data item through one or more of the following: a database application, a storage management application, a directory server application, a storage file system, a mail server application, a user administration application and a collaboration server application.

At 208, policy component 316 defines an archive policy as a function of the metadata such that data items satisfying said archival policy are to be moved from the primary storage (e.g. backup storage 322) to the secondary storage 324. At 210, an archival search criteria is defined as a function of the archival policy. And, at 212, the search engine 318 executes a search including the archival search criteria to generate a list of data items such that the metadata associated with each data item satisfies the archival policy. At 214, a data management application 320 is configured as a function of the generated list of data items such that data management application 320 moves each data item in the list of data items from primary storage (e.g. backup storage 322) to secondary storage 324.

For example, suppose a company wants to enforce a policy that all critical Human Resource data must be protected by the data management application 320 with a recovery range of 15 days from disk and then be archived to the secondary storage 324. Instead of the administrator expressing the policy container as HR database, HR documents in a given folder, the metadata tagging component 314 automatically tags this data as “HR Data” and also associates a classification tag such as “critical” appropriately. The metadata archival search criteria modeled as [select all Data within Enterprise where Department=“HR” and Importance=“critical”] will return all critical HR Data. The search will contain URLs for the source of the data and these URLs are used to configure the data management application 320 to setup the correct policy on all the specific endpoints which meet the search query. Periodically, the search will rerun the query and validate if new data needs to be protected and automatically to the configuration of the data management application 320.

In an embodiment, at 208, the policy component 316 defines a backup policy as a function of the metadata. Data items satisfying the backup policy are backed up. At 210, a backup search criteria is defined as a function of the backup policy. At 212, the search engine 318 executes the search including the backup search criteria to generate a list of data items such that the metadata associated with each data item satisfies the backup policy. At 214, the data management application 320 is configured as a function of the generated list of data items such the data management application 320 produces a backup of each data item in the list of data items.

In another embodiment, at 208 the policy component 316 defines a retention policy as a function of the metadata. Data items not satisfying are retention policy are to be deleted. At 210, a retention search criteria is defined as a function of the retention policy. At 212, the search engine 318 executes the search including the retention search criteria to generate a list of data items such that the metadata associated with each data item does not satisfy the retention policy. At 214, the data management application 320 is configured as a function of the generated list of data items such the data management application 320 deletes each data item in the list of data items.

FIG. 3 is a block diagram of an embodiment for a system for managing a plurality data items associated with a one or more servers (e.g., server 302, server 304) of an enterprise. FIG. 3 shows one example of a general purpose computing device in the form of a computer (e.g., server 302, server 304, and backup server 312). In one embodiment of the invention, a computer such as server 302, server 304, and/or backup server 312, herein referred to generally as server S, is suitable for use in the other figures illustrated and described herein. Server S has one or more processors or processing units, a system memory and at least some form of computer readable media. Computer readable media, which include both volatile and nonvolatile media, removable and non-removable media, may be any available medium that may be accessed by Server S. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by Server S.

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The Server S may operate in a networked environment using logical connections to one or more other computers. The Server S may be a personal computer, a server, a router, a network PC, a peer device or other common network node, and typically includes many or all of the elements described above relative to Server S. The logical connections depicted in FIG. 3 include a local area network (LAN) and a wide area network (WAN), but may also include other networks. LAN and/or WAN may be a wired network, a wireless network, a combination thereof, and so on. Such networking environments are commonplace in offices, enterprise-wide computer networks, intranets, and global computer networks (e.g., the Internet). The network connections shown are exemplary and other means of establishing a communications link between the computers may be used.

Generally, the data processors of Server S are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

Although described in connection with an exemplary computing system environment, including Server S embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The system includes one or more storage devices 306, 308, 310 of the data items and accessible by at least one of the servers. The backup server 312 includes one or more storage devices (e.g., backup storage 322, secondary storage 324), a metadata tagging component 314, a policy component 316, a search engine 318 and a data management application 320. The Server S may also include other removable/non-removable, volatile/nonvolatile computer storage media.

For example, FIG. 3 illustrates a storage device 306, 308, 310, 322, 324 that reads from or writes to non-removable, nonvolatile media and/or a removable, nonvolatile media. Removable/non-removable, volatile/nonvolatile computer storage media that may be used in the exemplary operating environment include, but are not limited to, magnetic disk, magnetic tape cassettes, flash memory cards, optical disks, digital versatile disks, digital video tape, solid state RAM, solid state ROM, and the like. The drives or other mass storage devices and their associated computer storage media discussed above and illustrated in FIG. 3, provide storage of computer readable instructions, data structures, program modules and other data for the Server S.

The metadata tagging component 314 associates metadata describing one or more attributes of each data item to each data item. The policy component 316 defining one or more data management polices as a function of the metadata. The search engine 318 for generating a list of data items satisfying the data management policy. The data management application 320 for applying the data management policy to each data item in the list of data items generated by the search engine 318.

For purposes of illustration, programs and other executable program components, such as the metadata tagging component 314, the policy component 316, the search engine 318 and the data management application 320, are illustrated herein as discrete blocks. It is recognized, however, that such programs and components reside at various times in different storage components of the computer, and are executed by the data processor(s) of the computer.

In an embodiment, the system includes a secondary storage 324 of the enterprise for storing data items of a second priority and the storage device includes data items of a first priority. The data management policy includes an archival policy wherein data items satisfying the archival policy are to be moved from the storage devices to the secondary storage 324. The search engine 318 generates a list of data items such that the metadata associated with each data item satisfies the archival policy. The data management application 320 moves each data item in the list of data items from the storage device to secondary storage 324.

In another embodiment, the data management policy includes a retention policy where data items not satisfying the retention policy are to be deleted. The search engine 318 generates a list of data items such that the metadata associated with each data item does not satisfy the retention policy and the data management application 320 deletes each data item in the list of data items.

In yet another embodiment, the data management policy includes a backup policy where the search engine 318 generates a list of data items such that the metadata associated with each data item satisfies the backup policy. The data management application 320 produces a backup of each data item in the list of data items.

In operation, Server S executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for managing a plurality data items associated with a one or more servers of an enterprise:
one or more storage devices, said devices including the data items and accessible by at least one of the servers;
a metadata tagging component for associating metadata to each data item, said metadata describing one or more attributes of each data item;
a policy component defining one or more data management polices as a function of the metadata;
a search engine for generating a list of data items satisfying the data management policy; and
a data management application for applying the data management policy to each data item in the list of data items generated by the search engine.

2. The system of claim 1, further comprising:
a secondary storage of the enterprise for storing data items of a second priority wherein the storage device includes data items of a first priority;
wherein the data management policy comprises an archival policy wherein data items satisfying said archival policy are to be moved from the storage devices to the secondary storage;
wherein the search engine generates a list of data items such that the metadata associated with each data item satisfies the archival policy; and
wherein the data management application moves each data item in the list of data items from the storage device to secondary storage.

3. The system of claim 1, further comprising:
wherein the data management policy comprises a retention policy wherein data items not satisfying said retention policy are to be deleted; and
wherein the search engine generates a list of data items such that the metadata associated with each data item does not satisfy the retention policy; and
wherein the data management application deletes each data item in the list of data items.

4. The system of claim 1, further comprising:
wherein the data management policy comprises a backup policy;
wherein the search engine generates a list of data items such that the metadata associated with each data item satisfies the backup policy; and
wherein the data management application produces a backup of each data item in the list of data items.

5. A method for backing up a data item associated with a server of an enterprise, comprising:
tagging the data item with metadata, said metadata describing one or more attributes of the data item;
defining a backup policy as a function of the metadata;
defining a backup search criteria as a function of the backup policy;
executing a search including the backup search criteria to generate a list of data items wherein the metadata associated with each data item satisfies the defined backup policy; and
configuring a data management application as a function of the generated list of data items, said data management application producing a backup of each data item in the generated list of data items.

6. The method of claim 5, wherein the data item is tagged with metadata by one or more of the following: a database application, a storage management application, a directory server application, a storage file system, a mail server application, a user administration application and a collaboration server application.

7. The method of claim 5, wherein the data item is tagged with metadata by an owner of the data item.

8. The method of claim 5, wherein the metadata indicates one or more of the following: a priority of the data item, a owner of the data item, a group of the data item, a last accessed time of the data item, a last modified time of the data item, a created time of the data item, an archival time of the data item, a logical location of the data item and a physical location of the data item.

9. The method of claim 5, further comprising:
defining a retention policy as a function of the metadata wherein data items not satisfying said retention policy are to be deleted;
defining a retention search criteria as a function of the backup policy;
executing the search including the retention search criteria to generate a list of data items wherein the metadata associated with each data item does not satisfy the retention policy; and
configuring the data management application as a function of the generated list of data items, wherein the data management application deleting each data item in the list of data items.

10. The method of claim 5, further comprising:
defining primary storage of the enterprise for storing data items of a first priority;
defining secondary storage of the enterprise for storing data items of a second priority;
defining an archival policy as a function of the metadata wherein data items satisfying said archival policy are to be moved from the primary storage to the secondary storage;
defining an archival search criteria as a function of the archival policy;
executing the search including the archival search criteria to generate a list of data items wherein the metadata associated with each data item satisfies the archival policy; and
configuring the data management application as a function of the generated list of data items, wherein the data management application moving each data item in the list of data items from primary storage to secondary storage.

11. The method of claim 10, wherein the primary storage includes online storage and the secondary storage includes near online and offline storage.

12. The method of claim 11, wherein online storage comprises one or more storage devices that are activated and ready for operation.

13. The method of claim 11, wherein offline storage comprises one or more storage devices are not readily available to the server.

14. A method for archiving a data item associated with a server, comprising:
defining primary storage of the server for storing data items of a first priority;
defining secondary storage of the server for storing data items of a second priority;
tagging the data item with metadata, said metadata describing one or more attributes of the data item;
defining an archive policy as a function of the metadata wherein data items satisfying said archival policy are to be moved from the primary storage to the secondary storage;
defining an archival search criteria as a function of the archival policy;
executing a search including the archival search criteria to generate a list of data items wherein the metadata associated with each data item satisfies the archival policy; and
configuring a data management application as a function of the generated list of data items, said data management application moving each data item in the list of data items from primary storage to secondary storage.

15. The method of claim 14, wherein the primary storage includes online storage and the secondary storage includes near online and offline storage.

16. The method of claim 15, wherein online storage comprises one or more storage devices that are activated and ready for operation.

17. The method of claim 15, wherein offline storage comprises one or more storage devices that are not readily available to the server.

18. The method of claim 14, further comprising:
defining a backup policy as a function of the metadata;
defining a backup search criteria as a function of the backup policy;
executing the search including the backup search criteria to generate a list of data items wherein the metadata associated with each data item satisfies the defined backup policy; and
configuring the data management application as a function of the generated list of data items, wherein the data management application produces a backup of each data item in the list of data items.

19. The method of claim 14, further comprising:
defining a retention policy as a function of the metadata wherein data items not satisfying said retention policy are to be deleted;
defining a retention search criteria as a function of the backup policy;
executing the search including the retention search criteria to generate a list of data items wherein the metadata associated with each data item does not satisfy the retention policy; and
configuring the data management application as a function of the generated list of data items, wherein the data management application deleting each data item in the list of data items.

20. The method of claim 14, wherein the metadata is associated with the data item through one or more of the following: a database application, a storage management application, a directory server application, a storage file system, a mail server application, a user administration application and a collaboration server application.
